(19) United States
(12) Patent Application Publication
(10) Pub. No.: US 2018/0087753 A1
(43) Pub. Date: Mar. 29, 2018

(54) Light Fixture with Adjustable Reflector Blades

(71) Applicant: John Yeh, Chino Hills, CA (US)

(72) Inventor: John Yeh, Chino Hills, CA (US)

(21) Appl. No.: 15/275,462

(22) Filed: Sep. 25, 2016

(51) Int. Cl. F21V 17/02; F21V 7/22; F21V 7/00; A01G 7/04; A01G 9/20

(52) U.S. Cl. CPC F21V 17/02; F21V 7/22; A01G 9/20; A01G 7/045; F21V 7/0025

(57) ABSTRACT

A light fixture has two reflective blades that are adjustable. Adjusting the setting on the reflective blades allows for the controlling of how widely or narrowly the light will be focused from the light fixture. The reflective blades reside within the light fixture, and are positioned on either side of the lamp. The reflective blades attach to the light fixture via a fastener on two ends of the light fixture's casing, while alloblade each reflective blade to pivot along the two fasteners. The reflective blades are pivoted along the fasteners, and are held stationary through the use of a spring loaded knob that has a rounded base for embedding itself with in receptacle on the light fixture's casing.

### BACKGROUND OF THE INVENTION

### Field of the Invention

This invention relates generally to a light fixture with reflectors, and more particularly to a light fixture with adjustable reflectors.

### Description of the Related Art

Light fixtures come in a variety of shapes and sizes, and just about all have reflectors for directing the light originating from the lamp. Generally, the reflectors within the light fixture are fixed, and direct the light in a particular direction and pattern. The light fixture itself may allow for adjusting where the light fixture is aimed, but the distribution pattern of the light, as controlled by the reflector, remains static.

The reflectors can control how widely or narrowly the light is reflected and spread as it travels away from the light fixture. In many situations, such as indoor horticulture, there is a desire to be able to control this. For example, there may be a case where there is a desire to place the light fixture further away from the plants, and thus higher up towards the ceiling, away from the plants. This allows for the plants to receive less heat from the light source. In this case, there may be a desire to have the reflectors angle the light so that it is dispersed more narrowly, as to compensate for the larger distance between the light fixture and the plants.

And in the opposite case, there may be a desire to place the light fixture closer to the plants, and thus lower down from the ceiling. In this case, having the reflectors set to more widely disperse the light will assist to accommodate the shorter distance between the light fixture and the plants. The wider dispersion will ensure the entire surface area of plants can receive light.

There is a desire across various applications and industries, such as indoor horticulture, to be able to more easily adjust the reflectors within a light fixture to control how widely the light will be spread across from the light fixture.

### BRIEF SUMMARY OF THE INVENTION

In a preferred embodiment, a light fixture is fitted with two reflective blades to allow for the adjustment of how the light is reflected from the light fixture. The reflective blades can be adjusted and angled between the widest setting and the narrowest setting. The widest setting will reflect the light more widely as the light exits from the light fixture. This will allow the light to be more dispersed and cover a larger surface area. Since the light is more dispersed, there is less concentration of light and heat directed at any given point on the lighted surface area. The narrowest setting will reflect the light in a more narrow fashion, and cover a smaller surface aware. Since the light is more concentrated, there is more concentration of light and heat directed at any given point on the lighted surface area.

### BRIEF DESCRIPTION OF THE DRAWINGS

A more complete appreciation of the invention and many of the advantages thereof will be readily obtained as the same becomes better understood by reference to the detailed description when considered in connection with the accompanying drawings, wherein:

FIG. 1 is a front view of an embodiment of a light fixture with adjustable reflectors.

FIG. 2 is a top view of an embodiment of a light fixture with adjustable reflectors.

FIG. 3 is a bottom perspective view of an embodiment of a light fixture with adjustable reflectors at the widest setting.

FIG. 4 is a top perspective view of an embodiment of a light fixture with adjustable reflectors at the widest setting.

FIG. 5 is a bottom perspective view of an embodiment of a light fixture with adjustable reflectors at the narrowest setting.

FIG. 6 is a top perspective view of an embodiment of a light fixture with adjustable reflectors at the narrowest setting.

FIG. 7 is a zoomed in view of an embodiment of a reflector blade's adjustment mechanism.

FIG. 8 is a zoomed in view of an embodiment of a reflector blade's adjustment mechanism.

### DETAILED DESCRIPTION

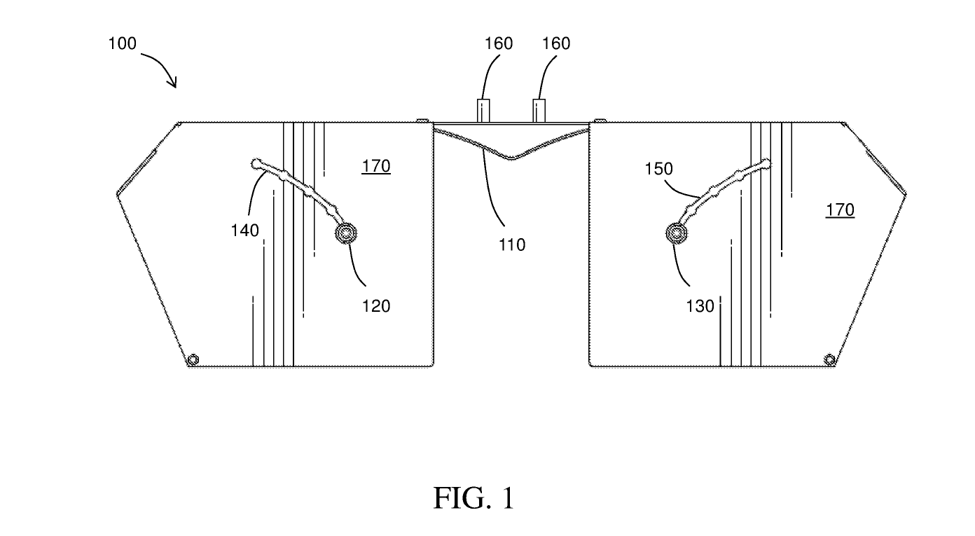

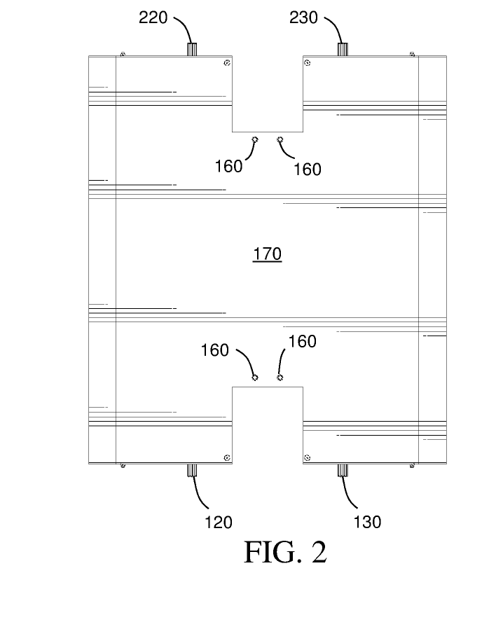

FIG. 1 shows a front view of a preferred embodiment of a light fixture with adjustable reflectors 100. FIG. 2 shows a top view. The front and back of the light fixture are symmetrical as are the left and right. The light fixture is comprised of a casing 170. In the preferred embodiment, the casing is made of a sturdy and heat tolerable metal material. On the inside of the casing is a reflective skin 110, which in a preferred embodiment is made from aluminum. The reflective skin 110 lines the inside of the casing, to reflect light outward from the bottom of the light fixture. The light is generated from a lamp that is mounted somewhere within the casing, and is not shown in the figures. The lamp may be a tube shaped lamp, and in a preferred embodiment, a single tube lamp is positioned longitudinal to the light fixture (assuming the length of the light fixture spans from front to back), and centered laterally (assuming the width of the light fixture spans from the left to right).

In this embodiment, the light fixture 100 can be mounted using mounting holes 160. Typically, the light fixture 100 will be mounted such that the light is targeted in the downward direction. There are various ways of mounting a light fixture, and in various directions, as is well known to those skilled in the art.

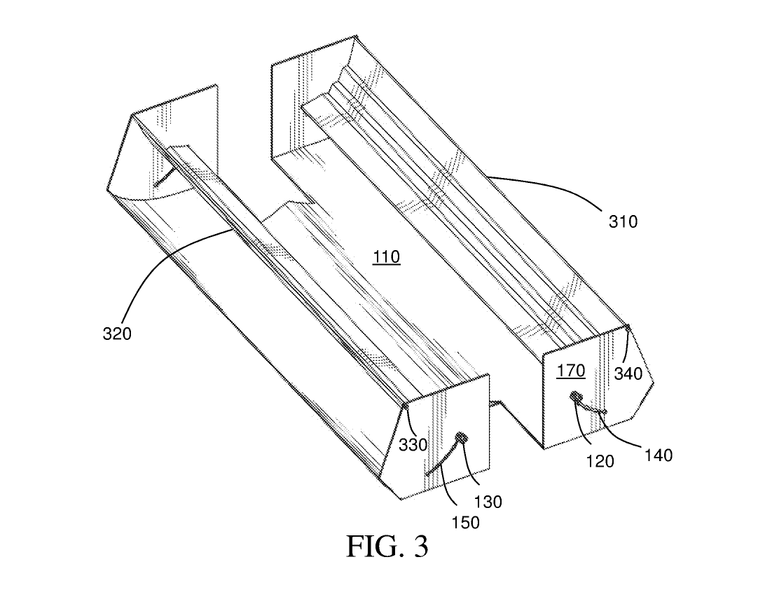

FIG. 3 shows the bottom side of the light fixture of the preferred embodiment, and shows the two reflector blades 310 320. There is a reflector blade 320 on the right side of the light fixture, and another reflector blade 310 on the left side of the light fixture. As FIG. 3 shows the light fixture from the bottom, the orientation of the left and right are reversed. As mentioned earlier, the light fixture's left and right sides are symmetrical. Although the left and right side of the light fixture is generally symmetrical, it should be noted that the left and right reflector blades can be placed in different positions.

The reflector blades 310 320 may be made of a reflective material or have a reflective skin, to maximize the amount of light that they reflect from the lamp (not shown). The reflective blades 310 320 may have a variety of shapes and rivets, and in a preferred embodiment, are concave towards the lamp (not shown). The reflector blades are fastened to the light fixture casing 170 at one end, and on the other end, may be rotated. For example, the right reflector blade 320 is fastened to the light fixture casing 170 at the front at 330 and correspondingly on back side of the light fixture casing. The right reflector blade 320 is able to pivot along these two fasteners. Similarly, the left reflector blade 310 is able to pivot along its fastener 340, along with the corresponding fastener on the back side of the light fixture's casing.

In this preferred embodiment, the other end of the reflector blades 310 320 are fixedly attached to a knob which provides for a mechanism of adjusting the position and angle of the reflector blades 310 320 at various settings. The right reflector blade 320 is fixedly attached to front knob 130, and there is back knob 230 fixedly attached to the right reflector blade 320 on the back side of the light fixture. The left reflector blade 310 is fixedly attached to front knob 120, and there is back knob 220 fixedly attached to the left reflector blade 310 on the back side of the light fixture. The front knob 130 runs along the track 150, and the other front knob 120 runs along the track 140. In FIG. 3, the reflector blades are both in the widest reflective position, meaning they will disperse the light from the lamp (not shown) in a wide light pattern.

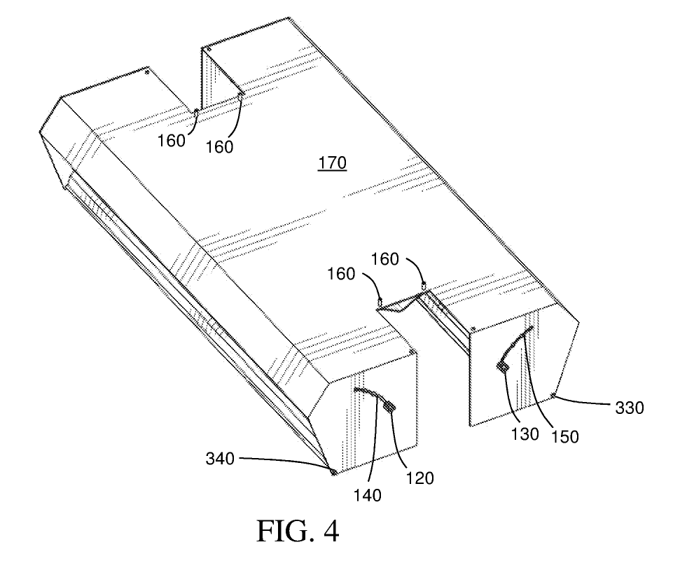

FIG. 4 shows the light fixture, from the top front perspective view, with the reflector blades both in the widest reflective position.

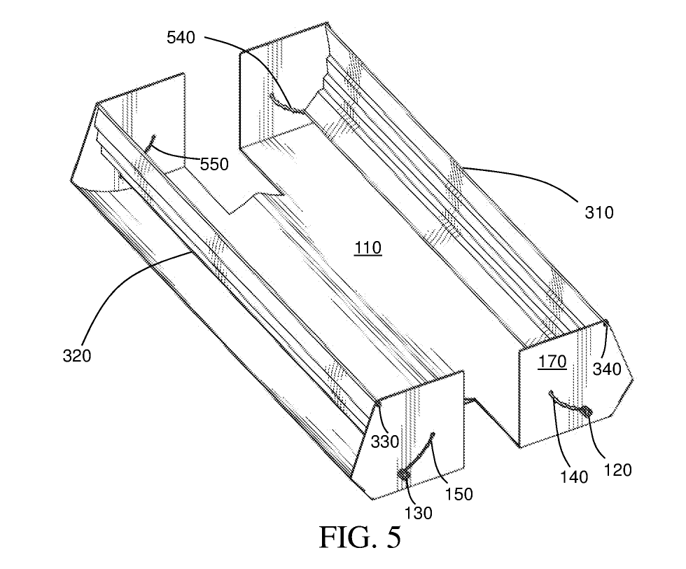

FIG. 5 shows the bottom side of the light fixture, and shows the two reflector blades 310 320 in their narrowest reflective setting. In this setting, the reflector blades are angled more perpendicular to the top of the light fixture than they were at the widest reflective setting. The reflector blades 310 320 will focus the reflection of the light from the lamp (not shown) in a more narrow pattern, down from the top of the light fixture. This adjustment from the widest reflective setting in FIG. 3 to this narrowest reflective setting is performed by adjusting the knobs 120 130 220 230 along their respective tracks 140 150 540 550 to achieve the desired angle.

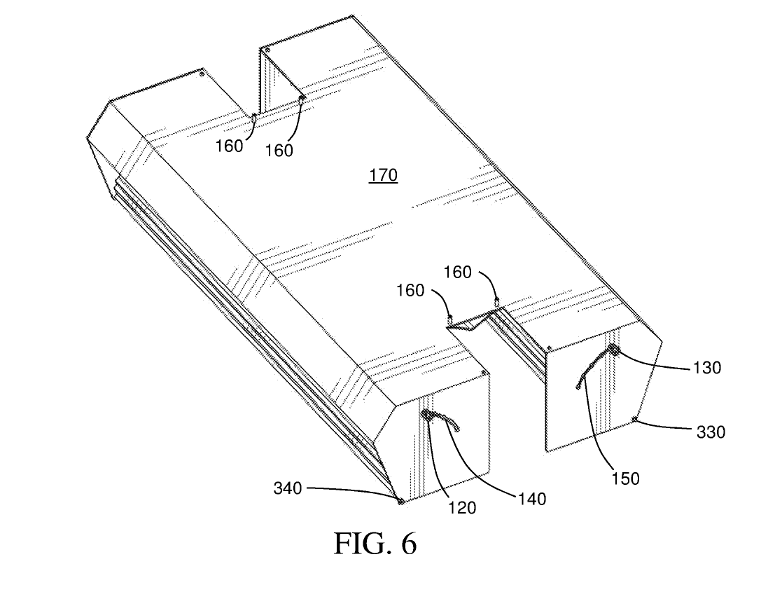

FIG. 6 shows the light fixture, from the top front perspective view, with the reflector blades both in the narrowest reflective position.

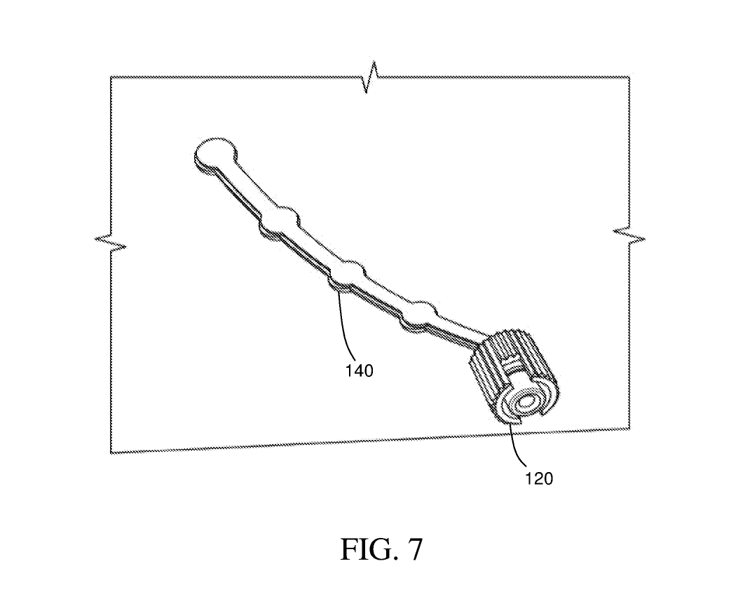

FIG. 7 shows a zoomed in view of one of the knobs 120 and track 140. In this preferred embodiment, there are five different settings, including the widest reflective setting, the narrowest reflecting setting, and three settings in between. In other embodiments, there may be more or fewer settings (aka steps) to adjust the angle of the reflective blade. FIG. 7 shows the adjustment mechanism of the preferred embodiment. Locking into the available steps can also be achieved through a variety of other known mechanisms, such as a ball plunger, pull pin, spring plungers, and quick release pin.

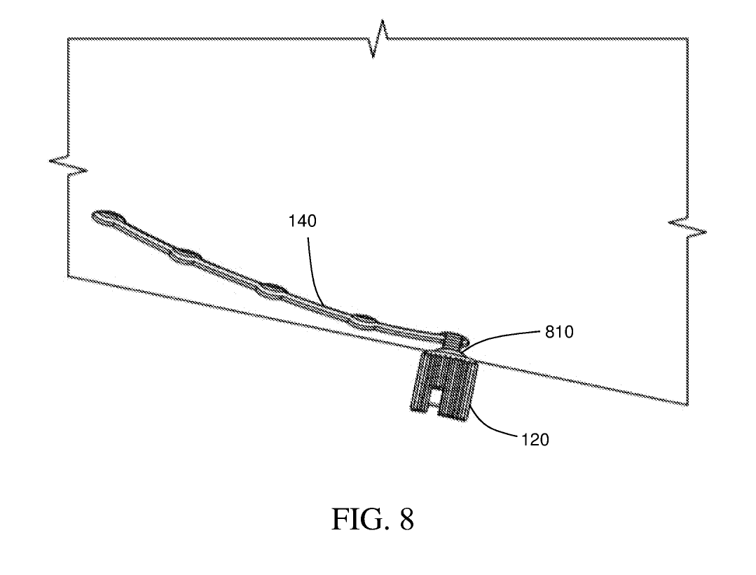

In the preferred embodiment, the knob 120 can be pulled, and is spring loaded so that when it is not pulled, it is automatically retracted towards the track 140. The knob 120 has a threaded screw at its base, and the knob is fixedly attached to the reflector blade by being screwed in to the reflector blade. FIG. 8 shows the knob 120 being pulled outwards. The bottom part of the knob has a rounded base 810, which snuggly fits within the receptacles (aka steps) on the track 140. When the knob is released on a receptacle (step), the rounded rear 810 fits into the receptacle to hold it in place. To adjust the setting of the reflector blade, the user pulls the two knobs fixedly attached to the reflector blade, and can adjust along the track 140 to the desired receptacle or setting.

Although the present invention has been described in detail with respect to certain embodiments and examples, variations and modifications exist which are within the scope of the present invention as defined in the following claims.

What is claimed is:

1. A light fixture comprising:
a casing comprising a front side, back side, left side, and right side;
a first reflective blade fastened to said casing on the left side, wherein said first reflective blade is fastened on said casing's front side and said casing's back side, enabling said first reflective blade to pivot along said fastened points;
and a second reflective blade fastened to said casing on the right side, wherein said second reflective blade is fastened on said casing's front side and said casing's back side, enabling said second reflective blade to pivot along said fastened points.

2. The light fixture of claim 1 wherein said first and second reflective blades are concave.

3. The light fixture of claim 2 further comprising of a track with receptacles on said front side of casing and a knob fixedly attached to said first reflective blade through said track.

4. The light fixture of claim 3 wherein said casing has an aluminum coating on the inside.

5. The light fixture of claim 3 wherein said first and second reflective blades have some aluminum coating.
